(19) United States
(12) Patent Application Publication
(10) Pub. No.: US 2009/0120571 A1
(43) Pub. Date: May 14, 2009

(54) Heat-sealable label

(76) Inventor: Max Otto Henri Rasmussen, Karlslunde (DK)

Correspondence Address: JACOBSON HOLMAN PLLC, 400 SEVENTH STREET N.W., SUITE 600, WASHINGTON, DC, 20004, US

(21) Appl. No.: 11/920,165

(22) PCT Filed: Apr. 28, 2006
(86) PCT No.: PCT/DK2006/000230

§ 371 Date: Jan. 17, 2008

(30) Foreign Application Priority Data
May 12, 2005 (EP) 05388041.5

(51) Int. Cl. B32B 37/04; B32B 3/10

(52) U.S. Cl. 156/283; 428/200

(57) ABSTRACT

The present invention relates to a heat-sealable label comprising a carrier layer, a print, and a heat-sealable adhesive layer, wherein the heat-sealable adhesive layer is a dried dispersion comprising polymeric particles having a coalescence temperature at or above 50° C. and at least 10% (w/w) of the total mass of said polymeric particles are constituted by particles having an average particle diameter of at least about 0.5 μm. This particular adhesive layer results in absence of a tendency of the labels to block when winded up in a roll. Thus, a release layer may be omitted, which allows for a label with more versatile surface properties.

The present invention relates to a heat-sealable label comprising a carrier layer, a print, and a heat-sealable adhesive layer. The invention also relates to a method for producing a labelled packaging material, which comprises contacting a surface of the packaging material with the heat-sealable adhesive layer face of the label.

### BACKGROUND

Self-adhering paper was invented in the mid-1930 and soon found an application as a label on various goods. Today, self-adhering labels are used in almost every industry, which produces a physical product. The appearance of the label may vary from a simple single coloured (usually black) print on a paper background to a decoration print in a multitude of coloured inks. Especially, in the food industry it is widely used to print a coloured decoration print on the label to attract the attention of the consumer.

Self-adhering labels are used in a considerable amount. Large industrial entities use millions of labels every year. The standard self-adhering label comprises a pressure sensitive adhesive attached to release liner. Prior to application of the label, the release liner is removed and the label is adhered to the surface of the product using a slight pressure. Several drawbacks are attached to this technology. Especially, the silicone-covered release liner creates problems due to handling and removal thereof. The release liner is difficult and expensive to recycle or degrade. Even the combustion in an incineration plant poses problems because of the formation of incineration residues in the ovens and the risk that the silicone release liner may act as a fuse. When the release liner acts as a fuse the fire in the ovens runs back to the storage of release liner and causes a fire there. Thus, some public incineration plants refuse to accept release liners directly from the industry unless the release liners are chopped into minor pieces.

Furthermore, the use of a release liner, adding no technical features to the final product, runs contrary to the general trend in industry of down-sizing the film thickness. It is not uncommon that the silicone-covered release liner, which has to be disposed of, weights more than the actual label. Typically, however, the release liner represents around 40-50% by weight of the total weight of the label. Removal and handling of the release liner results in high costs, environmental complications, and a complex industrial process.

A label using a heat-sealable adhesive layer has been produced in EP 489 960. The label is composed of a lower melting base film comprising a print, which is laminated to a transparent protective higher melting film. The lower melting film is on the face opposing the print attached to a release liner. Prior to the application of the label to a suitable surface, the release liner is removed. As indicated above, the release liner needs to be disposed of.

The development of so-called linerless labels alleviated some of the disadvantages caused by the silicone-covered liner. A linerless label comprises on the backing thereof an anti-adhesive release layer of e.g. silicone so the adhesive layer part of an over-laying label easy can be peeled off. However, the linerless labels have certain disadvantages. First, the weight of the label is still high, typically around 80-100 g/m². Second, the silicone covered backing reduces the printing possibilities. Third, it is technically complicated when an advanced printing using 5, 6, or 7 inks is desired.

The relative high weight adds to the cost of the label. The printing possibilities are generally reduced to a single colour (usually black) mainly using a so-called thermoprinting method as silicone effectively inhibits the attachment of most inks. Furthermore, the thermoprint is susceptible to sun light and heat, resulting in a fading over time. The technically complicated process results in long production times and special facilities.

DE 197 24 647 C1 discloses a linerless label using a fusible adhesive. The fusible adhesive is solid at room temperature and is heated to a temperature above its softening point at the application of the label. On the face opposite the adhesive layer a silicone layer is provided.

Traditional fusible adhesives have a broad softening range, which increases the risk of blocking during shipping, storing, stacking and otherwise handling. To avoid the risk of the sheets sticking together the silicone layer is necessary. Even in cases in which the optimal heat-seal temperature is around 150° C. a tendency to become tacky at room temperature may be observed.

U.S. Pat. No. 6,210,795 discloses a heat-sealable adhesive label with spacer particles. The adhesive label includes a substrate having a first surface and a second surface, and an adhesive coating disposed on the first surface of the substrate. The adhesive coating includes an adhesive and a plurality of spacer particles that impart roughness to the adhesive coating. The label reduces the formation of blisters and/or air pockets which may cause wrinkling and blistering of the applied label, particularly in in-mould applications. The heat-sealable adhesive labels reduce the amount of blocking, double feeding, and wrinkling of the labels when stacked and fed using commercial labelling equipment.

However, the incorporation of spacer particles in the adhesive layer is a cumbersome process that requires extra steps in the manufacturing process.

Further publications requiring an anti-adhesive layer include WO 02/055295, U.S. Pat. No. 5,508,247, U.S. Pat. No. 4,851,383, and EP 579 430.

The present invention aims at providing a linerless label having a heat sealable adhesive layer, which does not require an anti-adhesive layer, such as silicone, on the opposite side. Absence of the silicone layer allows for a decoration print on the front face of the label, the possibility of a thinner label, and a simpler label production. In addition, the present invention aims at avoiding inclusion in the adhesive layer of foreign solid particles not participating in the adhering.

### SUMMARY OF THE INVENTION

The present invention relates to a heat-sealable label comprising a carrier layer, a print, and a heat-sealable adhesive layer, where the heat-sealable adhesive layer is a dried dispersion comprising polymeric particles, wherein at least 10% (w/w) of the total mass of said polymeric particles are constituted by particles having an average particle diameter of at least about 0.5 μm and said polymeric particles having a coalescence temperature at or above 50° C.

The dried dispersion provides a porous layer, in which the individual particles are connected with each other in such a way that voids are present between the particles to provide for the porosity. The high coalescence temperature ensures that the polymeric particles do not become tacky during storing and handling at normal to slightly elevated temperatures.

While it is not desired to limit the invention to any specific explanation, it is presently assumed that the combination of a porous heat-sealable adhesive layer and non-tacky particles having significant different sizes results in the lack of blocking between layers of labels, when stored under static pressure with the adhesive side against the backing side of the label. Surprisingly, experiments have shown that the usual anti-adhesive layer, such as silicone, can be omitted on the backing. A further effect observed is the absence of the so-called mirror effect, i.e. the resistance of many films against being rolled off a roll due to e.g. electrostatic or hydrostatic forces.

Moreover, it has appeared that there is no need for foreign spacers or spacing particles in the heat-sealable adhesive layer. Normally foreign spacers or spacing particles are required to prevent undesired adhesion during storage, e.g. as disclosed in U.S. Pat. No. 6, 210,795.

The absence of the silicone layer allows for a more versatile label. Among other things, it is possible to obtain a surface of the label in accordance with any desire, e.g. a surface with a pearl or matt appearance or a label with a particular glossy surface for obtaining special effects. A label with a matt, non-reflecting surface is useful when sensitive bar-code scanners are used. Furthermore, the surface of the label can be adapted to receive a second print without the restrictions determined by the presence of silicone, in which thermo print appears to be the only commercially utilized method. A further possibility would be to apply a varnish on the second print for the protection thereof and to provide for the desired surface appearance.

A further advantage of the present invention over the commercial available linerless labels is the reduced material consumption. Whereas a typical linerless label weights about 100 g/m², it would be applicable according to the present invention to reduce the weight of the label to at least 50 g/m², preferably 35 g/m².

In a preferred aspect of the invention, at least 20% (w/w) of the total mass of said polymeric particles are constituted by particles having an average particle diameter of at least about 0.5 μm. Alternatively, or in addition, at least 10% (w/w) of the total mass of said polymeric particles are constituted by particles having an average particle diameter of at least about 1 μm.

While a specific polymer type of the adhesive layer dispersion is not critical, a presently preferred dispersion comprises polymeric particles of ethylene vinyl acetate copolymer. According to a specifically preferred embodiment the dispersion comprising ethylene vinyl acetate copolymer is Latiseal A7734A®, or Latiseal B7089AN®.

The print, carrier layer, and the adhesive layer can be positioned relative to each other in any suitable fashion. To protect the print from wear, it may be desired to position the print between the carrier layer and the heat-sealable adhesive layer.

The type of printing method is limited only by the choice of carrier layer and adhesive layer, i.e. print must in general be compatible with the layers in its immediate vicinity. In accordance with certain embodiments of the invention dispersion comprises polymeric particles of ethylene vinyl acetate copolymer.

As explained above, one of the advantages of the pre-sent invention is the possibility of applying a second print to the label, in which the choice of printing method is not restricted by the presence if a silicone layer. In accordance with certain embodiments the carrier layer is adapted to receive a second print selected among flexographic, off-set or gravure print.

An important feature of the present invention is the selection of the coalescence temperature. In the present description and claims, the coalescence temperature is defined as the temperature at which the individual particles begin to be confluent, i.e. the surface of the particles becomes sufficiently soft or melted for a physical connection to be established between the individual particles. When the temperature exceeds the coalescence temperature the voids between particles are displaced and a dense layer is obtained. A coalescence temperature at or above 50° C. normally secures a handling and a storing at which no blocking occurs. However, in certain applications it may be desirable or possible to use a lower coalescence temperature, such as coalescence temperature at 40° C. or above. In a preferred embodiment, however, the coalescence temperature is at or above 60° C.

In an even more preferred embodiment a coalescence temperature about or above 70° C. may be preferred, as such temperatures allow for e.g. an ethyleneoxid or gamma sterilisation in addition to adhesion of the label to the receiving package or foil.

The dispersion resulting in the dried heat-sealable adhesive layer may be based on water, organic solvents, or a combination thereof. In a certain aspect of the invention the dispersion comprising the polymeric particles is based on water. In the preferred aspect the aqueous dispersion may comprise a minor amount of organic solvent miscible with water. As an example, the aqueous dispersion may comprise less than 5% by weight, preferably less than 1% by weight of organic solvent.

The present invention also relates to a method for producing a labelled packaging material, which comprises contacting a surface of the packaging material with the heat-sealable adhesive layer face of the label described above at a temperature at least 10° C. above the coalescence temperature of said adhesive layer. In a certain embodiment, contacting between the label and the packaging material is effected at 70° C. or above.

### DETAILED DESCRIPTION OF THE INVENTION

The carrier layer may be any film with sufficient strength to be self-supporting. Suitable materials for the carrier layer are metals, polymers, paper, carton, or combinations thereof. In addition the carrier layer may be comprised of textile, including woven and non-woven fabrics made of natural or synthetic fibres.

The carrier layer may be a single-layered construction or it may be a multi-layered construction. The multi-layered construction has two or more layers, in particular a multi-layered construction has about two to about nine layers, suitably about two to seven layers, and preferably two, three, or five layers. The layers of such multi-layered construction may have the same composition and/or size or they may be different.

The metal foils include foils of such metals as copper, gold, silver, tin, chromium, zinc, nickel, platinum, palladium, iron, aluminium, steel, lead, brass, bronze, and alloys of the foregoing metals. Examples of such alloys include copper/zinc, copper/silver, copper/tin/zinc, copper/phosphorus, chromium/molybdenum, nickel/chromium, nickel/phosphorous, and the like.

The metal foils can be used by themselves or they can be joined or adhered to a polymeric sheet or film to form a multi-layered laminate or construction.

The polymer films include polyolefins (linear or branched), polyamides, polystyrenes, nylon, polyesters, polyester copolymers, polyurethanes, polysulfones, styrene-maleic anhydride copolymers, styrene-acrylonitrile copolymers, ionomers based on sodium or zinc salts of ethylene methacrylic acid, polymethyl methacrylates, cellulosics, acrylic polymers and copolymers, polycarbonates, polyacrylonitriles, and ethylene-vinyl acetate copolymers.

Included in this group are the acrylates such as ethylene methacrylic acid, ethylene methyl acrylate, ethylene acrylic acid and ethylene ethyl acrylate.

Also, included in this group are polymers and copolymers of olefin monomers having, for example, 2 to about 12 carbon atoms, and in one embodiment 2 to about 8 carbon atoms. These include the polymers of α-olefins having from 2 to about 4 carbon atoms per molecule. These include polyethylene, polypropylene, poly-1-butene, etc. An example of a copolymer within the above definition is a copolymer of ethylene with 1-butene having from about 1 to about 10 weight percent of the 1-butene comonomer incorporated into the copolymer molecule. The polyethylenes that are useful have various densities including low, medium and high density ranges. The low density range is from about 0.910 to about 0.925 g/cm³; the medium density range is from about 0.925 to about 0.940 g/cm³; and the high density range is from about 0.940 to about 0.965 g/cm³. Films prepared from blends of copolymers or blends of copolymers with homopolymers are also are useful. The films may be extruded as mono-layered films or multi-layered films.

The films may be oriented films or non-oriented films. Oriented films may be monoaxially or biaxially.

Suitable films include oriented polypropylene (abbreviated OPP), biaxially oriented polypropylene (BOPP), cast polypropylene (abbreviated CPP), oriented polyester, such as polyethylene terephthalate (abbreviated PETP), and laminates comprising and outer layer of low-density polyethylene (LDPE). In certain applications a cast polyamide (abbreviated CPA) or an oriented polyamide (abbreviated OPA) may be preferred. Particularly suitable commercially available films, used alone or in combination with other films, as the carrier layer include Plain OPP, available as Radici-film Radil C; Co-extruded BOPP, available as Type Bicor MB 400; LDPE coated BOPP, available as Type Bicor MB 440; acryl-coated BOPP, available as different types of Bicor film; cast polypropylene, available as e.g. Schur Flex CPP Mono 6214.01; oriented polyester (PETP), available as Melinex 813; cast Polyamide, available from MF-Folien GMBH, Porschestrasse 26, D-87437 Kempten; and biaxially oriented polyamide, available as Capran® from Honeywell Capran® Films, USA.

The carrier layer may be transparent, toned in any colour, or it may be pigmented. The pigments that can be used include titanium dioxide, both rutile and anatase crystal structure. In one embodiment, the pigment is added to the carrier layer material in the form of a concentrate containing the pigment and a resin carrier.

In a certain aspect of the invention, the print may be imbedded in the carrier layer. As an example, a first film may be flexographically printed and subsequently laminated to a secondary film. The first film may be a relatively thin film of 10 to 30 μm made of e.g. oriented plain polyester or oriented polypropylene, and the second film may be of polyethylene, especially low density polyethylene, and may be a coextruded foil. An embodiment in which the print is sandwiched between two films is well protected against wear or abrasion from the view side of the label and any blurring or deterioration of the print that might be effected by the adhesive dispersion is effectively hampered.

The surface of the carrier layer to be imprinted pre-treated prior to the printing. A suitable pre-treatment include corona treatment to raise the energy of the surface to allow for enhanced printing on it. Corona treatment involves discharging up to about 10,000 volts of electricity from a ceramic electrode to a ground roll over which the film is passing. Alternatively or in addition, the surface may be treated with a primer in order to provide for an enhanced attachment of the print to the carrier layer. The primer may also be used between the print and the adhesive coating to increase the attachment.

The material used to form the primer is comprised of a lacquer dissolved in a diluent. The lacquer is comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include ethanol, isopropanol, butanol, ethyl acetate, propyl acetate, butyl acetate, toluene, xylene, acetone, methyl ethyl ketone, heptane, and mixtures thereof. The ratio of lacquer to diluent is dependent on the viscosity required for application of the primer, the selection of such viscosity being within the skill of the art.

The primer may have a thickness in the range of about 1 to about 4 μm, and in one embodiment about 1.5 to about 3 μm.

The primer may for instance be a transparent adhesion primer (TORDA PRINTPRIMER 6500, obtained from TORDA INKS AB, \dot{A}kerlund & Rausingsväg, SE-22100 Lund, Sweden). This primer is of the polyurethane type and has a dry matter content of 40% (w/w). Another primer is ADCOTE 76 H 5, which is a solvent-based polyester primer with a dry matter content of 35% (w/w) and dilutable with methylethylketone methylene chloride. ADCOTE 76H 5 is produced by Rohm and Haas Company, 100 Independence Mall West, Philadelphia, Pa. 19106-2399, USA. A further useful primer is LIOSEAL V 6250, which is a solvent-based print-primer with a 39% solids-content and which may be applied at 1.2 gr/m² for improved adhesion of printing inks. LIOSEAL V 6250 is manufactured by Henkel KGaA, Henkelstrasse 67, Düsseldorf, Germany.

The heat-sealable adhesive layer is generally applied to the carrier film as a liquid dispersion. The dispersed particles may comprise any suitable polymer having a coalescence temperature in the desired range. The polymeric particles are dispersed in a suitable liquid, which may be based on water or an organic solvent. In certain embodiments, the liquid is a mixture of water and an organic solvent. Besides the polymer particles the liquid, the dispersion may comprise further components, such as surfactants.

The choice of liquid for the dispersion depends among other things on the nature of the materials in close connection with the dispersion. As an example, a dispersion based on organic solvents may be preferred for certain qualities of paper or carton known to swell when contacted with water. Conversely, water based dispersions may be preferred when a polymer carrier film is used. When possible, it is generally preferred to use a dispersion based on water due to belief that organic solvents can be harmful to the human being.

According to the invention, the polymeric particles have a coalesce temperature of at least 50° C. Preferably the coalescence temperature is not higher than 200° C. as most polymers tend to shrink at this temperature. However, for certain applications it may desired to use polymeric particles having a coalescence temperature above 200° C., e.g. in case the carrier layer is a thermo resistant material like metal. However, in general it is preferred that the coalescence temperature is below 120° C. as some commonly used packaging films shrink above this temperature. Preferably, the coalescence temperature is selected between 60 and 110° C.

The dimension of the particles is generally in the range of 0.1 μm to 15 μm, preferably between 0.2 and 10 μm, more preferably between 0.3 and 5 μm. Without being bound to the theory it is assumed that the larger particles functions as spacers during storage and provides the excellent properties of the adhesive layer. Consequently, it is desired that the particles have a great difference in average diameter and typically the particles have a span >2, where the span is defined as (D₉₀-D₁₀)/D₅₀ in which D₁₀ D₅₀ and D₉₀ denotes the diameters of the 10% quantile, the 50% quantile and the 90% quantile, respectively. Preferably the span is >2.3, more preferably the span is >2.5.

Water-based polymer dispersions suitable for forming the dried adhesive layer used in the present invention, includes dispersions based on acrylic polymers or ethylene-vinyl acetate copolymers. The invention comprises a dried dispersion of polymeric particles comprising any proportion of ethylene and vinyl acetate monomers, as long as a coalescence temperature at 50° C. or above is obtained. In a preferred aspect a coalescence temperature at 60° C. or above is obtained. Generally, the higher the proportion of vinyl acetate in the polymeric particle, the lower the coalescence temperature. Therefore, the relative proportion of the monomers and the molecular weight of the copolymer are normally adjusted in accordance with the desired properties. In a certain aspect of the invention the concentration of the vinyl acetate in the polymeric particles is between 5 and 40% (w/w). Examples of dispersions suitable for performing the present invention include Latiseal A7734A, or Latiseal B7089AN, obtainable from the company Sovereign Speciality Chemicals, Buffalo, USA.

According to the product data sheet of Latiseal® A7734A, the coalescence temperature is 70° C. When this product is applied on a surface and allowed to dry at a temperature below 70° C. a white porous coating is formed. Treated at temperatures above 70° C. the coating will coalesce and leave a clear non-porous film. It is recommended to use a temperature above 95° C. to fully activate the adhesive. The data sheet of Latiseal® B7089AN indicates a coalescence temperature of 160° F. (71° C.). When drying the dispersion at temperatures below the coalescence point a white porous coating is obtained and a clear non-porous layer is obtained when the temperature is raised above the coalescence temperature. To activate the resin sufficiently, it is recommended to use a temperature at or above 215° F. (102° C.).

A label wherein the dispersion comprises polymeric particles of ethylene-vinyl acetate copolymer has particular interesting properties. Apart from very good all over heat seal abilities at low sealing temperatures ethylene-vinyl acetate copolymer offers also other important properties in relation to EU and FDA regulations for Adhesives and Food Contact Materials. Ethylene-vinyl acetate copolymer heat seal coatings offers much wider and safer use as Food Packaging Labels compared with most other types of acrylic pressure sensitive adhesives or polyurethane heat seal coatings for labels, due to limitation of use in terms of functional barrier and good manufacturing practise. Because FDA regards “pin-hole free” aluminium foil only as a functional barrier, the choice of pressure sensitive adhesives and heat seal adhesives is limited.

The European Commission is preparing a new directive on food-contact plastics, the so-called “Super Directive” on plastics, which seeks to consolidate, revise and repeal several Community Directives relating to food-contact plastic materials. In particular, the proposed Super Directive would replace the current Plastics Directive 2002/72/EC and its forthcoming amendments, as well as two directives on migration testing (82/711/EEC and 85/572/EEC) and three directives on vinyl chloride monomer (78/142/EEC, 80/766/EEC and 81/432/EEC).

The draft Super Directive indicates that those multi-layer materials that fall within the scope of the Directive must comply with the overall migration and specific migration requirements of the Directive and that they must be made of positively listed substances, as single layer materials. However, multi-layers could be exempted from those requirements provided there is a conclusive proof of the existence of a “functional barrier” between the layers and the food that prevents migration of unauthorized substances.

In USA the FDA regulation 21 CFR 175.125 Pressure Sensitive Adhesives is restricting the choice of adhesive-raw materials to a rather limited technical level of adhesive-performance, which means that labels made with adhesives, complying with this FDA regulation, have very limited use in a wider scale in modern labelling. For general purposes food labels, labels with demanding properties or labels with high performance technical properties, the adhesives must be chosen from raw materials mentioned under FDA regulation 21 CFR 175.105 ADHESIVES or FDA regulation 21 CFR 177.1390 Laminate Structures for use at temperatures of 250 F (121° C.) and above. When forced to use adhesive-raw materials complying with FDA regulation 21 CFR 175.105 ADHESIVES, the user must make sure that the adhesive is prepared from one or more of the optional substances named in paragraph (c) of this section, subject to any prescribed limitations. Further, that the adhesive is either separated from the food by a functional barrier or used subject to good manufacturing practice. FDA Regulations on Good Manufacturing Practice is covered by FDA Regulations 21 CFR 110.3 GMP through FDA Reg. 21 CFR 110.110 GMP, which gives instruction for Good Manufacturing Practice in relation to measures to limit migration into foodstuff.

In case of the absence of a functional barrier as per the definition by FDA—(which only accepts pin-hole free aluminium foil as a functional barrier)—adhesive-raw materials must be chosen from the substance-list mentioned in FDA Regulation 21 CFR 177.1390 Laminate Structures. This will limit the choice of adhesive-raw materials for pressure sensitive adhesives to a minimum, probably eliminating practical use of labels made according to this FDA Regulation 21 CFR 177.1390 Laminate Structures for use at temperatures of 250° F. (121° C.) and above.

FDA accepts only pin-hole free aluminium foil as a functional barrier and do not accept films made from polyolefin resins—such as LDPE films, LLDPE films, OPP film, PP films, BOPP films, HDPE films—as functional barrier. Neither do FDA accept 12 μm OPA films, 20 μm OPA films, 30 μm OPA films, 12 μm Polyester-films, or laminates of these transparent films in combination with the mentioned polyolefin-films as functional barrier. FDA's measures on Public Health Security & Bioterrorism Preparedness and Response Act of 2002, has put more stringent demands to compliance with functional barrier in transparent packaging materials.

Migration of adhesive-substances to the foodstuff in quantities, which could endanger human health has been investigated by Jens Højslev Petersen, Danish Veterinary and Food Administration, Copenhagen, Denmark in “A pilot study on migration from food packaging labels” presented at NORDIC SEMINAR on Adhesives in food contact materials and articles, June 2001, where the realistic danger of migration of adhesives substances into foodstuff has been established.

In case of absence of a functional barrier or alternatively in case of cracks in the packaging film, on which the labels are applied, allowing direct contact between the adhesive and foodstuff, dispersions of ethylene vinyl acetate copolymer, such as Latiseal® A7734A, which comply with FDA Regulations 21 CFR 175.300 Resinous and polymeric coatings are particularly interesting as a preferred heat seal coating, because this FDA regulations permits direct contact with the foodstuff. Latiseal A7734A is included in the reported test in the examples part of the present description and shows superior capabilities.

The print may be referred to as the graphic layer or the decoration herein. The print may be mono-coloured or multi-coloured ink layers, depending on the printed message and/or pictorial design. Multi-colour printing is well known in the prior art, i.e. applying several layers of different inks consecutively or on top of each other.

The ink employed may be of any suitable type, e.g. nitrocellulose, PVB, acrylic, acrylate or combinations thereof. In addition, the inks may be offset inks, e.g. oil-based or water-based. The ink may have any colour or be uncoloured.

The inks may be based on any solvent; in particular, they may be dilutable in ethanol, isopropanol, ethyl-lacetate, methylethylketone, acetone, water or combinations thereof. Furthermore, solvent-free inks, i.e. water-based inks may be used.

The inks used according to the invention may be single-component, dual-component and/or even three-component inks. Single-component inks are immediately employable for printing, possibly after having been diluted by a suitable solvent. Dual-component inks are foreseen to be mixed immediately before use.

The inks used in the print may be cured by heat or radiation and selected in accordance with the particular printing method used. In certain embodiments UV curable inks are appropriately chosen.

The print may be a direct or a reverse print. A reverse print is generally used when the decoration of the label is viewed though the carrier layer. A direct print is view directly and printed on the front side of the carrier layer.

To protect the decoration e.g. against wear, it is preferred to use the reverse printing method, in which the decoration is sandwiched between the carrier layer and the adhesive layer or between two films. The surface opposite the print is in certain applications matt, especially when it is intended that a scanner should be used to scan a bar code or similar identification means.

The print is typical a decoration print in 4, 5, 6, 7, 8, 9, or even 10 colours. The first colour in a direct print is generally a background colour, wholly or partly covering the carrier layer. The background colour is usually white, but can of course be another if desired. The subsequent colours produce the different layers in the decoration. For a decoration produced in accordance with the reverse printing method, the last colour is the background colour.

When a direct print is used, it may be useful to utilize an overprint varnish to protect the print against wear or moisture. The overprint varnish may e.g. be of the UV or EB curable type. The UV curable overprint varnish may be made from UV curable oligomers such as epoxies, urethanes, polyesters, acrylic, and the like. These oligomers are cured by free-radicals generated by photoinitiators after exposure to UV light. Reactive diluents such as hexanediol diacrylate, pentaerythritol, tetraacrylate, N-vinylpyrrolidinone, and the like, can be used to control viscosity of the coating before cure and to modify the crosslink density. Epoxy resins and alkyl vinyl ethers, which are cationically cured, can also be used. Reactive diluents such as vinyl ethers, limonen dioxide, glycidyl ether, and the like, can be used. The coating may also contain wetting agents, leveling agents, waxes, slip aids, and light stabilizers. A commercially available coating material that can be used is RCA01302R-UV Coating which is available from Sun Chemical.

In a preferred aspect of the invention, the adhesive dispersion is applied to the print in an in-line process. Thus, after the inks have been applied and dried, the adhesive dispersion is applied in an even thickness. The application techniques include gravure, reverse gravure, offset gravure, roll coating, brushing, knife-over roll, metering rod, reverse roll coating, doctor knife, dipping, die coating, spraying, curtain coating, flexographic, letter press, rotary screen, flat screen, and the like. The dispersion is subsequently dried at a temperature below the coalescence temperature. The applied dispersion layer may be cured by exposure to heat or to known forms of ionizing or actinic non-ionizing radiation. Curing temperatures that may be used may range from about 40° C. to about 100° C., and in one embodiment about 40° C. to about 60° C. Useful types of radiation include ultraviolet light, infrared light, electron beam, x-ray, gamma-ray, beta-ray, etc. The equipment for generating these forms of thermal cure or radiation cure are well known to those skilled in the art.

In certain applications it might be desired to obtain a partly coalesced adhesive layer by allowing the individual polymeric particles to fuse together in the surfaces thereof. One such application might be, when a risk for high abrasion exist as the partly coalesced layer is more resistant towards contact with sharp items.

Besides being fast and rational, the in-line process has the advantage of the possibility of using a low carrier layer thickness. Practical experiments reported herein indicate that it is possible to use carrier layers having a thickness of 30 μm or higher. It is anticipated, that it should be possible to use carrier layers of a thickness below 30 μm, e.g. carrier layers having a thickness of 10 μm, 15 μm, 20 μm or higher. It is evident that the present label obtains a dramatic reduction in material consumption compared to a standard pressure sensitive label material with a total thickness of 160-180 μm.

The inventive heat-sealable label may be adhered to any substrate using heat-sealing techniques known in the art. Generally, the heat sealable label is placed on a substrate with the surface of heat activatable adhesive layer in contact with the substrate. Heat and pressure are applied to the label in contact with the substrate in any order. In one aspect, the heat and pressure are applied by a heated platen. The heat passes through the label to the heat-activatable adhesive layer and softens or melts the heat-activatable adhesive layer. The heat and pressure are removed, and the heat-activatable adhesive layer cools and solidifies resulting in the formation of a heat-sealed bond between the label and the substrate. Pressures in the range of about 2 to about 20 psi, and in one embodiment about 8 to about 12 psi, may be used. To allow for solidification dwell times of about 0.5 to about 60 seconds, and in one embodiment about 0.5 to 20 seconds, and in one embodiment about 0.5 to about 10 seconds may be used. Alternatively, the heat is supplied from the substrate side, i.e. after the label and the substrate has been brought into intimate contact with each other, a heating source situated on the substrate side of the combination is activated. In another aspect, the adhesive is first heated and then a pressure is applied to attach the label or the substrate. The heat may be applied by any suitable means, e.g. a hot fan, infrared irradiation, etc.

When the labels are attached the substrate via rolls, the roll facing the label, the roll facing the substrate or both may be heated.

The label according to the present invention is generally applied to a packaging material at a temperature well above the coalescence temperature to ensure a sufficient low viscosity of the adhesive. Normally, the label is heat sealed to the packaging material at a temperature at least 10° C. above the coalescence temperature, or preferred at a temperature at least 20° C. above the coalescence temperature. In commercially available dispersions the recommended temperature for application is sometimes referred to as the activation or reactivation temperature. As some carrier films tend to shrink at temperature above 130° C. it is generally desired to use an all-round adhesive dispersion with an application temperature below this point. Suitably, the label according to the invention is heat-sealed to the packaging material at a temperature between 85° C. and 125° C.

The carrier film should be selected such that the shrinking temperature is well above the temperature applied for heat-sealing the label to the packaging material. Similar, the packaging material should be selected such that no or only an insubstantial shrinking occurs.

It was a surprising finding that the label according to the invention adhered well to a wide range of packaging materials used commercially. Prior to the conduction of the experiments reported herein it was suspected that the surface of the packaging material should be adapted for receiving the heat-sealable adhesive. However, the practical experiments show that the labels of the invention adhere well to i.a. polypropylene, polyethylene, polyamide, polyester, and carton. The ability of the label to adhere satisfactory to almost any surface is of convenience for the persons performing the labelling, as there is no need to adjust the labelling machine if another packaging material is used. Also, the lack of sensitiveness towards the surface on which the label is adhered reduces the risk of mal-operation of the labelling machine resulting in labels detaching form the surface during storing or handling.

Furthermore, the label of the invention can be adhered to a packaging material using commonly used labelling machines like HM LINERFREE or HM 500, possibly slightly modified. The machines can be obtained from HM Labelling A/S, Tingvejen 30 N, DK-6500 Vojens, Denmark. The modification of the known labelling machines may include e.g. provision of a lamination roll, having the ability to become heated to the heat-seal temperature. Other modifications may include means for provision of an air shut pressure, a hot stamping, a direct IR heating on the heat-seal coating prior to contacting, etc.

The dispersion comprising the polymeric particles is generally applied to the entire surface of the carrier layer. However, for certain applications of the label it may be desirable to coat the surface in a pattern. As examples, the pattern may include spots, rings, polygons, or other geometrical figures in any dimension.

The label of the invention may be adapted to be positioned on the outer side or the inner side of a film wrapped around a product or a container comprising a product. For most applications the label is suitably heat-sealed to the outer surface of the packaging material. Though, some advantages arise from attaching the label to the inner side of the film, as it is impossible then to peel off the label without destroying the wrapping film. Such tamper-proof attachment of labels finds applications in the fight against counterfeit in securing the originality of the product. As an example, the label may be chosen to be a hologram. For foodstuff, it is generally preferred to use an adhesive having a high resistance towards moisture, such as Latiseal® A7734HS.

Various methods for transferring a label from a roll to a packaging material exist and any of these methods are included in the present invention. In a suitable method the labelling machine is provided with cutting means, which cuts around the label prior to heat-sealing thereof to a packaging material. A useful machine is of the type HM LINERFREE LABELLER, suitably modified to be able to apply heat to the label. This machine is available from HM Labelling A/S, Tingvejen 30 N, DK-6500 Vojens, Denmark.

Another commonly used method is the so-called punch-through labelling. Modified traditional labelling machines of e.g. the type H&M 500, produced by H&M Maskiner Vojens Denmark can perform punch-through labelling using the labels of the present invention. The principle of the punch-trough labelling method include that a perforation is made at the perimeter of the label. A perforation tool on the packaging machine can make the perforation or a pre-perforation can be performed in an in-line process in addition to the printing and adhesive application process. Many exiting label printing machines can be used also for the pre-perforation e.g. label printing machines of the type Nilpeter, Slagelse, Denmark and Omet, Locco, Italy.

Alternatively, instead of performing a perforation in the entire perimeter, one can perform a pre-cut in a part of the label and perform the last cut in connection with the heat-sealing to the packaging material. As an example of the latter application method, a label having a quadrangle form can be pre-cut at three sides so as to form a tongue, and subsequently the remaining side of the label can be cut to release the label during the heat-sealing process.

The label is applied on the packaging material by a punching mechanism, which may or may not be heated to a temperature above the coalescence temperature of the polymeric particle of the dried dispersion. In case the punching mechanism is heated sufficiently, the label is heat-sealed to the packaging material. In case the punching mechanism has a temperature below the activation temperature of the dispersion, the label is subsequent heat-sealed in a heating zone, e.g. using a heating roll, to attach the label to the packaging material or a hot stamping method.

In the punch-trough method, the individual labels are generally spaced by sufficient distance, e.g. about 0.5 to 2 cm, in the length as well as the breadth direction to ensure integrity of the foil after the labels have been transferred to the receiving packaging material. The spent foil with holes after the punched-out labels is generally rolled on a wheel and disposed of in a suitable way. If the carrier layer is based on a polymer it is normally possible to reuse the spent material.

The choice of material for the carrier layer may depend on the method of application. Generally, it is preferred to use a carrier layer of a material having high tear strength for the punch-through label. A suitable carrier layer material for a punch through label is cast polypropylene, e.g. in a thickness of 10 to 40 μm, preferably 15 to 35 μm.

### BRIEF DESCRIPTION OF THE DRAWINGS

FIG. 1 discloses a prior art label having a liner to protect a self-adhesive coating.

FIG. 2 shows a prior art label of the linerless type.

FIG. 3 depicts a label according to the invention, in which a mono-layered carrier film is utilized.

FIG. 4 discloses an embodiment is which the print is positioned within a laminate.

FIG. 5 depicts an embodiment in which the carrier layer is a laminate.

FIG. 6 shows an embodiment in which the print is protected with a varnish.

FIG. 7 depicts a stock basis label, adapted to receive a print.

FIG. 8 shows an embodiment using a transparent adhesion primer.

FIG. 9 depicts a label comprising a holographic of decoration print.

FIG. 10 is a SEM photography showing the polymer particles according to the invention. The variation in size is clearly seen.

FIG. 11 is SEM photography showing polymer particles according to the prior art disclosed in U.S. Pat. No. 6,210,795. The particles have a very uniform size.

### DETAILED DESCRIPTION OF THE DRAWINGS

Average diameter of a particle is defined as the diameter of a sphere having the same volume as the particle.

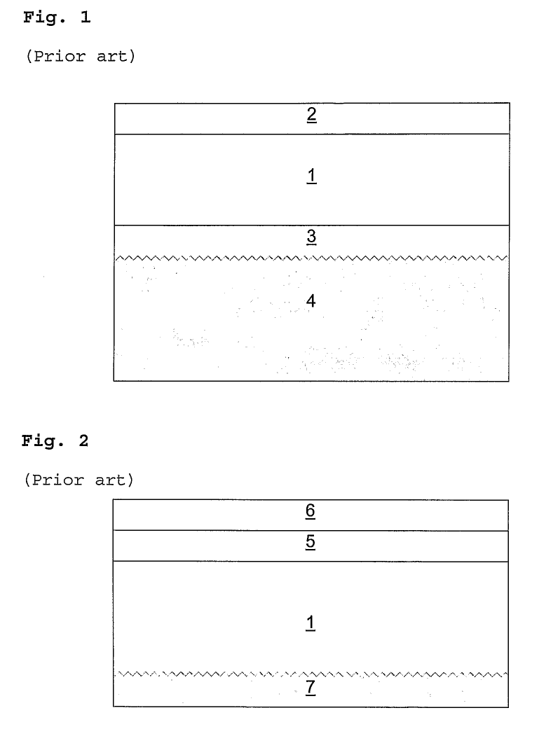

FIG. 1 shows a prior art release liner label widely used in industry. The label comprises a carrier layer 1 of 60 g/m² top coated paper, a print 2, and a pressure sensitive adhesive layer 3 having a thickness of 20 g/m². A release liner 4 of paper covered with silicone is attached to the adhesive layer. The release liner weights 60 g/m² and is destined to be removed prior to application on the packaging material of the label. The total weight of the label is 140 g/m².

FIG. 2 describes a typical prior art label of the linerless type. A carrier film 1 of 80 g/m² paper is provided on one side with a thermo-print reactive surface coating 6 and on the other side with a 20 g/m² self-adhering adhesive 7. The surface coating 5 is provided with a silicone release coating to prevent blocking of the label liner when winded up in a roll.

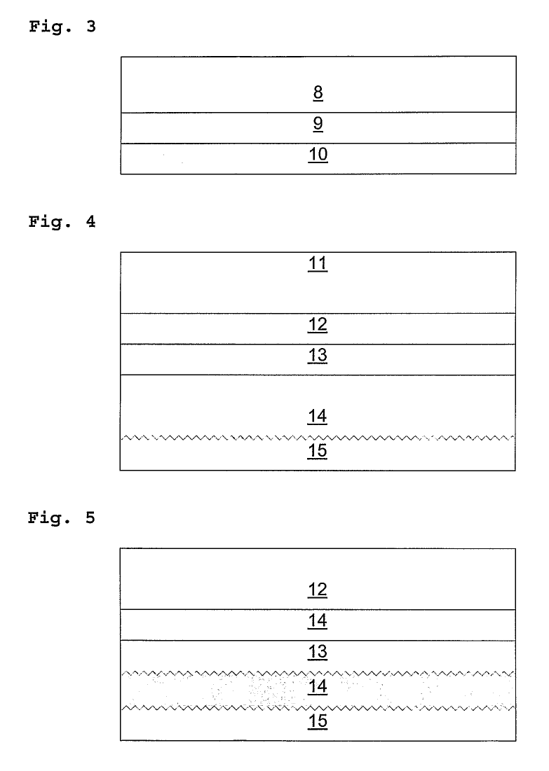

FIG. 3 shows a schematic representation of an embodiment of the invention. A carrier layer 8 is provided with a print 9, which in turn is covered by a dried dispersion of polymeric particles 10. Suitable examples of the carrier layer film 8 include a 30 μm plain CPP film, a 12 μm oriented polyester such as PETP, or a 30 μm plain OPP film. The print may suitably be selected as a 6-8 colour flexographic or gravure print. The adhesive layer 10 suitably comprises 4-5 g/m² heat-sealable coating. A suitable dispersion is Latiseal A7734A applied in an amount of approximately 12 g/m² and allowed to dry at a temperature below the coalescence temperature of the polymeric particles so as to form a dry coating having a dry matter content of around 5 g/m².

FIG. 4 shows an embodiment is which the print is positioned within a laminate. The label according to the embodiment shown in FIG. 4 may be produced by printing a 15 μm OPP film 11 with a 6-8 colour flexographic or Gravure Print 12 and subsequently provide the printed face with a solvent-free or solventless laminating adhesive 13 and laminating thereto a film 14, such as a 30 μm LDPE lamination film. The LDPE face of the laminate is subsequently provided with the heat-sealable coating 15, such as Latiseal® A7734A.

FIG. 5 depicts an embodiment in which the carrier layer is a laminate. The laminate may be produced by laminating a 12 μm oriented polyester film (PETP) 12 to a 30 μm LDPE lamination film using 1.7 gr/m² solventfree or solventless laminating adhesive 14. The laminate is subsequently printed on the LDPE side with a 6-8 colours flexographic or gravure print 14. A heat-sealable coating 15 is applied on the print as a last operation.

FIG. 6 shows an embodiment in which the print is protected with a varnish. A carrier layer 16 composed of 60 g/m² paper or polymeric film, such as OPP, is covered with a white ink 17 as a background colour. Subsequently, a 6-8 flexographic or gravure print 18 is provided. The print 18 is protected with a UV or EB cured overprint varnish (OPV) 19. On the other side of the carrier layer 16 a dry dispersion of polymeric particles 20 having a coalescence temperature above 50° C. is provided.

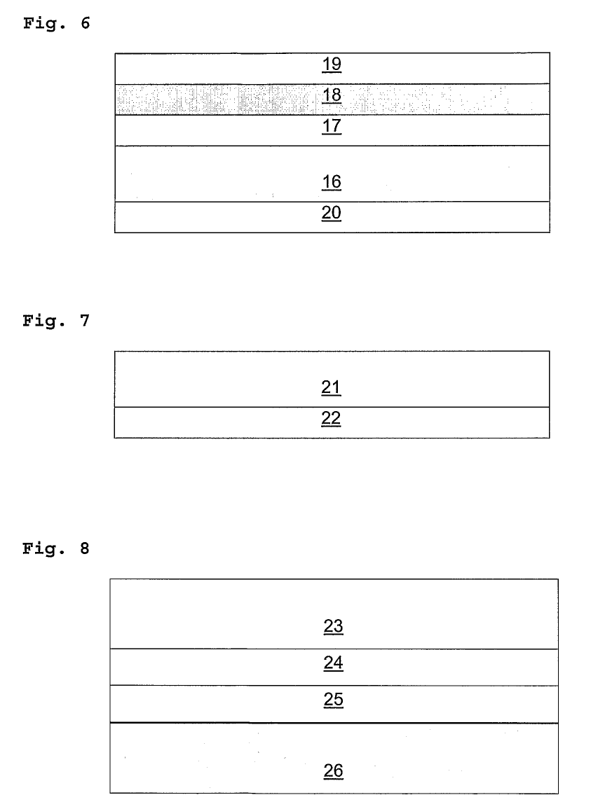

FIG. 7 depicts a stock basis label, adapted to receive a print. The label comprises a non-transparent carrier layer 21 of e.g. 40 μm white OPALYTE or 60 g/m² white paper. The carrier layer is covered with a heat-sealable adhesive layer provided by drying an aqueous dispersion of polymeric particles. An example of a suitable dispersion is Latiseal A7734A. The surface of the carrier layer 21 is adapted to receive a print, such as a thermo transfer print.

The unprinted label can be used as a stock basis label, which may be provided with the print just prior to the use of the label. The label may find application within the facilities of a company in order to identify specific items with a bar code or similar identification means.

FIG. 8 shows an embodiment in which an adhesion primer is utilized for enhancing the attachment of the print to the carrier layer. A 30 μm plain OPP film 23 is covered with a transparent adhesion primer 24 (TORDA PRINTPRIMER 6500, obtained from TORDA INKS AB, \dot{A}kerlund & Rausingsväg, SE-22100 Lund, Sweden) in an amount of around 1-2 g/m². The primer is of the polyurethane type and has a dry matter content of 40% (w/w). An alternative primer is ADCOTE 76 H 5, which is a solvent-based polyester primer with a dry matter content of 35% (w/w) and dilutable with methylethylketone methylene chloride. ADCOTE 76 H 5 is produced by Rohm and Haas Company, 100 Independence Mall West, Philadelphia, Pa. 19106-2399, USA. This primer is suggested applied in a dry matter content corresponding to around 1.2 g/m². Another suitable primer is Lioseal V 6250 manufactured by Henkel KgaA, Dusseldorf, Germany.

A print 25, such as a 6 to 8 colour flexographic or gravure print, is performed on the primer. As a last step a heat-sealable dispersion 26 is applied on the print and allowed to dry. The dispersion is applied in an amount of 4-5 g/m² dry matter. In an alternative embodiment, the primer 24 and the print 25 are applied in reverse order, i.e. the print is first applied the carrier layer followed by the primer. This alternative embodiment is especially useful when an incompatibility is present between the print layer and the adhesive dispersion. As an example, a metalized imprint may be prevented from being attacked by the adhesive dispersion by the presence of a primer. In a still further embodiment a primer layer may be present on both sides of the print 25.

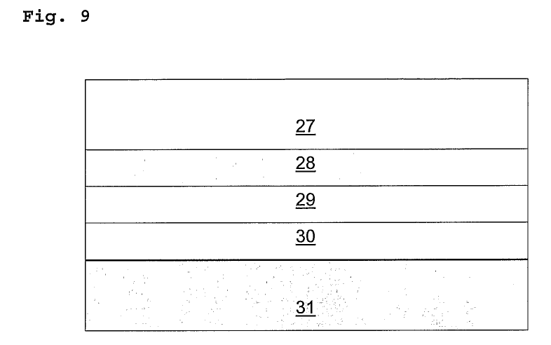

FIG. 9 discloses an embodiment in which a carrier layer, such as 30 μm plain OPP film 27, is embossed and subsequently metallized to form a holographic decoration 28. A primer 29 in an amount of e.g. 1-2 g/m² covers the holographic decoration. Subsequently a 6-8 colours flexographic or gravure print 30 is performed. The print is covered with a dried dispersion of an adhesive 31, e.g. Latiseal® A7734A, in an amount of 3-5 g/m².

In the following, the present invention will be illustrated by means of examples; however, these examples are not to be considered as a limitation of the scope of the protection. The examples are merely intended to show certain specific embodiments of the invention and the skilled person will know that the elements of these embodiments can be exchanged with other elements performing essentially the same function.

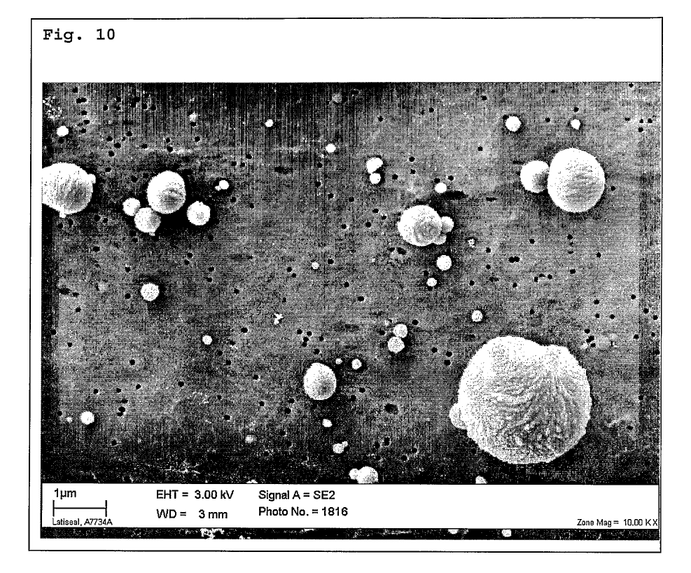

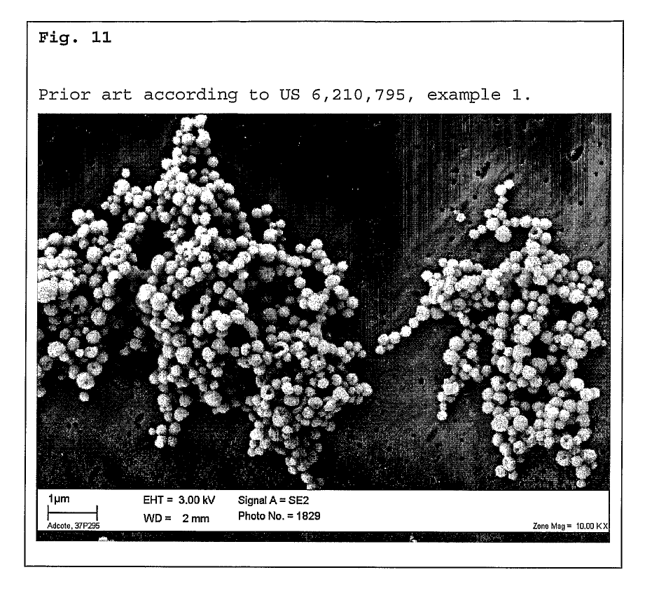

FIGS. 10 and 11 clearly demonstrates the significant difference in particle size and particle distribution of the polymer particles in the heat-sealable layer between the present invention (FIG. 10) and the prior art (FIG. 11). It is assumed that the larger polymer particles in the heat-sealable layer according to the invention function as spacers and eliminate the risk of undesired adherence during storage.

### EXAMPLES

### Example 1

A 12μ Mylar 800 Oriented Polyester film (PETP) from DuPont Teijin Films was coated with 5 g/m² (dry weight) of a water-based ethyl vinyl acetate copolymer dispersion (Latiseal A7734A obtained from Sovereign Speciality Chemicals, Buffalo, USA) using a gravure method. The wet dispersion was dried under an infrared lamp and a gas permeable, white, porous coating appeared. Latiseal A7734A comprises 44% (W/W) solids and water as the main liquid component. The product also comprises about 0.5% of aromatic hydrocarbon solvent. The coalescence temperature is about 70° C.

This coated film was heat sealed at 40 psi and 90° C. and 110° C., respectively, to 8 different films:

Film 1: 30 μm Radil C Mono BOPP film manufactured by Radicifilm, Italy.

Film 2: Laminate of 30 μm Bicor MB 400 and 40 μm LLDPE Marked PAELLA, manufactured by Neoplex, Nyborg Denmark.

Film 3: Laminate of 30 μm Bicor MB 440 and 35 μm LLDPE, Marked IGLO, manufactured by Neoplex, Nyborg Denmark.

Film 4: Laminate of 12 μm Melinex and 50 μm Curex LDPE film, pilot laminated by Herberts/DuPont Surface Coatings, Wuppertal, Germany.

Film 5: Monofilm of 20 μm MYLAR 820 manufactured by DuPont Teijin Films, USA.

Film 6: Laminate of 30 μm cast polyamide (CPA) and 50 μm Curex LDPE film, pilot laminated by Herberts/DuPont Surface Coatings, Wuppertal, Germany.

Film 7: Monofilm of 20 μm oriented polyamide (OPA) film marked TORDA Reference Sample.

Film 8: Carton, 300 grams/m².

The temperature treated sandwich was allowed to cool to room temperature and sliced onto strips of 15 mm. The adhesion between the films was measured as the force (expressed in grams) needed to separate the films according to DIN 53357.

The data obtained is indicated in the table I below:

TABLE 1

| | 90° C. | 110° C. |
|---|---|---|
| | (g/15 mm) | (g/15 mm) |
| Film 1 | 50 | 65 |
| Film 2 | 90 | 120 |
| Film 3 | 200 | 280 |
| Film 4 | 350 | 450 |
| Film 5 | 100 | — |
| Film 6 | 280 | 470 |
| Film 7 | 100 | 150 |
| Film 8 | 450 | 550 |

### Example 2

A 30 μm BICOR MB 400 BOPP film from Exxon/Mobil Chemicals was coated with 5 g/m² (dry weight) of a water-based ethyl vinyl acetate copolymer dispersion (Latiseal A7734A, obtained from Sovereign Speciality Chemicals, USA) using a gravure method. The wet dispersion was dried under an infrared lamp and a gas permeable, white, porous coating appeared.

The coated film was heat-sealed at 40 psi and at the temperature indicated in table II to the list of films indicated in example 1. The temperature treated sandwich was allowed to cool to room temperature and sliced onto strips of 15 mm. The adhesion between the films was measured as the force expressed in gram needed to separate the films according to DIN 53357.

The data obtained is indicated in the table II below:

TABLE II

| | 90° C. | 110° C. | 120° C. | 130° C. |
|---|---|---|---|---|
| | (g/15 mm) | (g/15 mm) | (g/15 mm) | (g/15 mm) |
| Film 1 | 40 | 65 | 120 | 140 |
| Film 2 | 70 | 170 | — | 220 |
| Film 3 | 120 | 300 | — | — |
| Film 4 | 300 | 450 | — | — |
| Film 5 | — | — | — | — |
| Film 6 | 430 | 500 | — | — |
| Film 7 | 130 | 180 | 200 | 230 |
| Film 8 | 450 | 540 | | |

### Example 3

A 12μ Mylar 800 Oriented Polyester film (PETP) from DuPont Teijin Films was printed with a white ink (Torda inks RPW White 015, obtained from Torda Inks, Lund, Sweden) and subsequently coated with 5 g/m² (dry weight) of a water-based ethyl vinyl acetate copolymer dispersion (Latiseal B7089AN obtained from Sovereign Speciality Chemicals, USA) using a gravure method. The wet dispersion was dried under an infra-red lamp and a gas permeable, white, porous coating appeared. Latiseal B7089AN comprises a solids content of 37.0% (W/W) and water as the main liquid component. The product also comprises about 0.5% of aromatic hydrocarbon solvent. The coalescence temperature is about 71° C.

This coated film was heatsealed at 40 psi and various temperatures as indicated in table III below:

TABLE III

| | 110° C. | 120° C. | 130° C. |
|---|---|---|---|
| | (g/15 mm) | (g/15 mm) | (g/15 mm) |
| Film 1 | 170 | — | 470 |
| Film 2 | 170 | 250 | — |

### Example 4

A 12μ Mylar 800 Oriented Polyester film (PETP) from DuPont Teijin Films was printed with Torda RPW Blue 004 obtained from Torda Inks, Lund, Sweden. The printed face of the film was coated with 5 g/m² (dry weight) of a water-based ethyl vinyl acetate copolymer dispersion (Latiseal B7089AN obtained from Sovereign Speciality Chemicals, USA) using a gravure method. The wet dispersion was dried under an infra-red lamp and a gas permeable, white, porous coating appeared.

This coated film was heatsealed at various temperatures as indicated in table IV below:

TABLE IV

| | 110° C. | 120° C. | 130° C. |
|---|---|---|---|
| | (g/15 mm) | (g/15 mm) | (g/15 mm) |
| Film 1 | 50 | 150 | 150 |
| Film 2 | 350 | — | — |

### Example 5

A 12μ Mylar 800 Oriented Polyester film (PETP) from DuPont Teijin Films was coated with 5 g/m² (dry weight) of a water-based ethyl vinyl acetate copolymer dispersion (Latiseal A7734A obtained from Sovereign Speciality Chemicals, USA) using a gravure method. The wet dispersion was dried under an infra-red lamp and a gas permeable, white, porous coating appeared.

The coated side of this film was heat-sealed at 40 psi to the polyethylene side of a laminate of 12 μm polyethylene terephthalate and 50 μm low-density polyethylene (LDPE) at 90° C., 110° C., and 130° C. The force needed to separate the films was measured in the manner indicated in example 1 to 120 g, 140 g, and 150 g, respectively.

### Example 6

A 30 μm BICOR MB 400 BOPP film from Exxon/Mobil Chemicals was coated with 5 g/m² (dry weight) of a water-based ethyl vinyl acetate copolymer dispersion (Latiseal A7734A, obtained from Sovereign Speciality Chemicals, USA) using a gravure method. The wet dispersion was dried under an infrared lamp and a gas permeable, white, porous coating appeared.

The coated side of this film was heat-sealed at 40 psi to the polyethylene side of a laminate of 12 μm polyethylene terephthalate and 50 μm low-density polyethylene (LDPE) at 90° C., 110° C., and 130° C. The force needed to separate the films was measured in the manner indicated in example 1 to 110 g, 130 g, and 170 g, respectively.

### Example 7

A blocking test was conducted with all films coated with the heat-sealable adhesive layer used in example 1 to 6. The test simulates the conditions of the film when winded up in a roll. In a first step of the test two coated films were superimposed such that the adhesive face of one film was placed on the carrier film of a second film. Then, a static pressure of 10 kg/cm² was applied for 24 hours at room temperature. The blocking tests showed that none of the films adhered to each other.

1. A heat-sealable label comprising a carrier layer, a print, and a heat-sealable adhesive layer, where the heat-sealable adhesive layer is a dried dispersion comprising polymeric particles, wherein at least 10% (w/w) of the total mass of said polymeric particles are constituted by particles having an average particle diameter of at least about 0.5 μm and said polymeric particles having a coalescence temperature at or above 50° C.

2. A label according to claim 1, wherein at least 20% (w/w) of the total mass of said polymeric particles are constituted by particles having an average particle diameter of at least about 0.5 μm.

3. A label according to claim 1, wherein at least 10% (w/w) of the total mass of said polymeric particles are constituted by particles having an average particle diameter of at least about 1 μm.

4. A label according to claim 1, wherein the dispersion comprises polymeric particles of ethylene vinyl acetate copolymer.

5. A label according to claim 4, wherein the dispersion comprising ethylene vinyl acetate copolymer is Latiseal A7734A®.

6. A label according to claim 1, wherein the print is positioned between the carrier layer and the heat-sealable adhesive layer.

7. A label according to claim 1, wherein the print is a holographic impression, flexographic, off-set or gravure print.

8. A label according to claim 1, wherein the surface of the carrier layer opposite the printed face is adapted to receive a second print.

9. A label according to claim 7, wherein the second print is a flexographic, off-set or gravure print.

10. A label according to claim 1, wherein the coalescence temperature is at or above 60° C.

11. A label according to claim 1, wherein the dispersion comprising polymeric particles is water-based.

12. A label according to claim 1, wherein the span of the polymeric particles is at least 2, preferably at least 2.3, more preferably at least 2.5.

13. A label according to claim 1, wherein the polymeric particles have an average particle diameter of about 0.1 to 10.0 μm, preferable the polymeric particles have an average particle diameter of about 0.2 to 5 μm

14. A method for producing a labelled packaging material, which comprises contacting a surface of the packaging material with the heat-sealable adhesive layer face of the label according to claim 1, at a temperature at least 10° C. above the coalescence temperature of said adhesive layer.

15. The method according to claim 14, wherein the contacting between the label and the packaging material is effected at 70° C. or above.
